(19) United States
(12) Patent Application Publication
(10) Pub. No.: US 2026/0161364 A1
(43) Pub. Date: Jun. 11, 2026

(54) AUTOMATED CODE GENERATION BASED ON REINFORCEMENT LEARNING WITH COMPILER FEEDBACK

(71) Applicant: International Business Machines Corporation, Armonk, NY (US)

(72) Inventors: Sthanikam SANTHOSH KUMAR, Punganuru (IN); Shailaja D N, BANGALORE (IN); Manish Kumar DASH, Khallikote (IN); Supriya DEVIDUTTA, Bhubaneswar (IN)

(21) Appl. No.: 18/972,835

(22) Filed: Dec. 6, 2024

(51) Int. Cl. G06F 8/20; G06F 8/41; G06F 11/3604

(52) U.S. Cl. CPC G06F 8/24; G06F 8/41; G06F 11/3616

(57) ABSTRACT

In some implementations, a machine learning (ML) component may generate a first mapping object including electronic data interchange mapping source code. The first mapping object may be compiled into a first compiled object and a feedback signal may be generated during compiling. The ML component may be trained based on the first compiled object and the feedback signal, and used to generate a second mapping object.

### BACKGROUND

The present invention relates to data processing, and for example, relates to automated code generation based on reinforcement learning with compiler feedback.

### SUMMARY

A computer system comprises a processor set; one or more computer-readable storage media; and program instructions stored on the one or more computer-readable storage media to cause the processor set to perform operations. The operations may include generating a first mapping object comprising electronic data interchange mapping source code; performing a compiling operation to compile the first mapping object into a first compiled object; generating, based on the compiling operation, a feedback signal comprising at least one compiler error or at least one data error; generating, by a machine learning component trained by a reinforcement learning operation based on the first compiled object and the feedback signal, a second mapping object; and outputting the second mapping object for execution by a map engine.

Some implementations include a computer-implemented method comprising generating a first mapping object comprising electronic data interchange mapping source code; performing a compiling operation to compile the first mapping object into a first compiled object; generating, based on the compiling operation, a feedback signal comprising at least one compiler error or at least one data error; generating, by a machine learning component trained by a reinforcement learning operation based on the first compiled object and the feedback signal, a second mapping object; and outputting the second mapping object for execution by a map engine.

Some implementations include a computer program product comprising one or more computer-readable storage media; and program instructions stored on the one or more computer-readable storage media to perform operations. The operations may include generating a first mapping object comprising electronic data interchange mapping source code; performing a compiling operation to compile the first mapping object into a first compiled object; generating, based on the compiling operation, a feedback signal comprising at least one compiler error or at least one data error; generating, by a machine learning component trained by a reinforcement learning operation based on the first compiled object and the feedback signal, a second mapping object; and outputting the second mapping object for execution by a map engine.

### BRIEF DESCRIPTION OF THE DRAWINGS

FIG. 1A is a block diagram of an example system described herein.

FIGS. 1B and 1C are schematic block diagrams of an example of a process for automated code generation based on reinforcement learning with compiler feedback (RLCF).

FIG. 2 is a schematic block diagram showing an example implementation associated with automated code generation based on RLCF described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with automated code generation based on RLCF described herein.

### DETAILED DESCRIPTION

The following detailed description of example implementations refers to the accompanying drawings. The same reference numbers in different drawings may identify the same or similar elements.

Electronic Data Interchange (EDI) is the communication of electronic documents from the computing systems of one entity to another entity. In some instances, the implementation of EDI involves the use of a standard electronic format that replaces paper-based documents, such as purchase orders or invoices. By automating paper-based transactions, organizations can save time and eliminate costly errors caused by manual processing.

In EDI transactions, information moves directly from a computer application in one organization to a computer application in another. EDI standards define the location and order of information in a document format. With this automated capability, data can be shared rapidly instead of over hours, days or weeks as required when using paper documents or other methods. However, EDI requires that the entities involved abide by the agreed upon EDI standards or have some means of conversion to the EDI standard, such as via an EDI mapping solution. Thus, if an entity wishes to utilize their own formatting of electronic documents locally in their own computing systems, in order to communicate that information to another entity, they must be able to convert their local format to the standardized format, or the format of the receiving entity.

Today, industries use EDI integration to share a range of document types, from purchase orders to invoices to requests for quotations to loan applications and more. In most instances, these organizations are trading partners that exchange goods and services frequently as part of their supply chains and business-to-business (B2B) networks. However, EDI mapping

may be required to be provided for each possible document type, format, and potential use at the receiving entity.

EDI mapping plays an important role in the EDI process, where one format of a document is converted to another so that the entities involved in the transfer of documentation are able to utilize the information contained therein with their own computing systems according to their own local formats. To illustrate this EDI mapping, it is first beneficial to appreciate the necessity of this information conversion. With EDI, an entity that wants to trade electronic documents with another entity, will either send those electronic documents in the format that is native to their respective computing system or application, e.g., an Enterprise Resource Planning (ERP) tool, or will send the electronic documents in one of the global standardized formats. However, the receiving entity may not necessarily follow the same standards as the sender. It is also very likely that the hierarchy of the tags and fields in the electronic document may be different from the hierarchy that the receiving entity can utilize or is expecting. Hence, to ensure the electronic document is understood by both the sending and receiving entities, translation of the electronic document from one format to another, without losing or misinterpreting any information is important. Hereafter, the electronic documents will be referred to simply as “documents”, but it should be understood that these “documents” are data structures storing information that may be conveyed through electronic means.

Conversion of documents exchanged electronically between two entities is not a simple task. The electronic document conversion from the source format of the sender entity, to a consumable format used by the recipient entity needs contemplation of usage scenarios, execution of several iterations of conversion and transfer, exchange of sample files (Input and Output), creation of Document type Definition files (DDF) for source and destination, and finally

creating a map that can be executed by a map engine for doing translation from the source format to the destination format. A map refers to a compiled mapping object (referred to herein interchangeably as a “compiled object”). The compiled mapping object is a set of compiled source code configured to cause a map engine to perform the conversion of documents from a source format to a different format (e.g., a consumable format or a destination format). As used herein, the term “engine” may include software, hardware, or a combination of software and hardware constructed, programmed, configured, or otherwise adapted, to carry out a function or set of functions.

Making this process even more complex is the fact that sometimes each of the sender and recipient entities may have different scenarios which require the creation of new maps, e.g., each entity may have different applications, computer systems, departments, individuals, or the like, that may need to utilize the information in an electronic document in a different way and may need the information provided in different formats to facilitate such.

Once the map is created, running and maintaining the map in production can be difficult as there can be a high dependency on the mapping skills of human beings required to design and maintain the mapping objects in the production environment. The whole process of creating a mapping object and maintaining the mapping object can be time consuming and cost sensitive. It has been estimated that generating and maintaining the maps account for approximately 80% of the costs in generating and maintaining EDI solutions.

To address this challenge, a machine learning (ML) component configured to automatically generate and maintain maps for execution by map engines to facilitate document format conversion for EDI may be used. A machine learning (ML) component refers to software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

The ML component described herein facilitates source code generation for defining a map to be executed by a map engine to facilitate mapping documents from one format used by a source entity (referred to herein as a “source node”), to a second format used by a destination entity (referred to herein as a “destination node”). The ML component may generate the source code in an open-source programming language. In some implementations, the ML component can provide improved functionality that automatically generates source code for performing a mapping, and automatically maintains that source code for mapping, so that the mapping may be automatically and dynamically updated for various scenarios, usages, and the like, that may be present for different elements of the entities or which may develop over time.

The ML component may be configured to generate the map based on scenarios defined in a mapping requirement specification (MRS). In some cases, for example, the ML component may generate source code based on sample input data (e.g. a sample source document), sample output data (e.g., a sample destination document), and an MRS. The source data may be, for example, a sample of an EDI source transaction file, for example, such as an X12 standard formatted document sample. The destination document may be a sample of an EDI destination transaction file, for example, such as an EDIFACT formatted document sample. The MRS may include the rules and logic involved in performing the translation from the source format to the destination format, e.g., X12 to EDIFACT in this example. Using these inputs, the ML component can automatically generate source code that can be executed to translate a document from the source format to the destination format, e.g., X12 format to EDIFACT format.

In some implementations, the ML component may include a number of encoders and a decoder, each of which may be a recurrent neural network (RNN). For example, a first encoder can be configured to encode the source document into a first fixed length vector output, or embedding. A second encoder can be configured to encode the destination document into a second fixed length vector output, or embedding. A third encoder can be configured to encode the MRS specified translation rules and logic into a third fixed length vector output, or embedding. The vector outputs represent embeddings of the contents of the source document, destination document, and MRS rules/logic which may be passed as input to the decoder which generates the source code for mapping from the source document format to the destination document format in accordance with the rules/logic specified in the MRS. That is, the decoder combines the embedding vector outputs from the encoders and generates an output vector that is mapped to source code snippets such that the sequence of values in the vector output of the decoder represents a sequence of source code snippets that together provide the source code for mapping from the source document format to the destination document format in accordance with the rules of the MRS. The encoders and decoder are trained through ML processes to generate the source code based on source documents, destination documents, and MRS rules/logic.

With respect to training ML components, two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, differentiating, and independent features is important for effective operation of the ML component in pattern recognition, classification, and regression. Features may be of different types, such as numeric features, strings, and graphs.

ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing (NLP), ML training software can employ a learning paradigm focused on human preferences to better align pretrained and instruction-tuned generative language models with human values. This process involves the ML training software collecting extensive data, where each data point comprises a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

RL has emerged as a prominent training methodology for ML components that are employed to automate the generation of source code for software development, particularly in scenarios where deterministic rules for generating correct code are infeasible or unavailable. For example, training data samples of source documents, destination documents, and MRS rules/logic can be input to the respective encoders, and the corresponding source code embeddings can be generated. The generated embeddings can then be passed to the decoder and a final output can be generated. This final output can be compared to a ground truth to determine a loss. The loss can then used by ML training logic, e.g., back-propagation, to update operational parameters with adjustments to the encoders and decoder to determine modified operational parameters that attempt to reduce the loss until a convergence criterion is achieved, e.g., a loss equal to or below a threshold loss or a predetermined number of training iterations/epochs are performed. In this way, the encoders and decoder learn a correlation between input patterns of text in the respective ones of the source document, destination document, and MRS, and corresponding source code that are output as the embedding vector outputs of the decoder.

In the context of code generation, compiler feedback serves as a useful evaluation mechanism, as compilers can identify errors and verify whether the generated source code is syntactically and semantically correct. Reinforcement learning with compiler feedback (RLCF) leverages compiler outputs as a reward signal to guide the training of ML models toward generating syntactically valid and executable code. However, existing implementations of RLCF are often constrained by the simplicity of the feedback signal provided to the learning agent.

For example, RLCF systems typically rely on binary reward signals to train ML components. For example, such systems may assign a reward of “1” for successfully compiled source code and a reward of “0” for code that fails to compile. While this binary feedback is straightforward to implement, it provides limited information about the nature and severity of compilation errors, resulting in inefficient learning processes. Without finer-grained feedback, the model may struggle to discern the specific changes required to correct errors, leading to slower convergence and suboptimal performance. Furthermore, existing approaches do not utilize valuable compiler outputs, such as error codes, the severity or intensity of errors, or the generated compiled source code itself, as part of the training data. As a result, these systems are unable to effectively leverage the rich diagnostic information available from the compilation process to refine their understanding of how to produce valid and optimal code.

Implementations of this disclosure address problems such as these by utilizing a technique for training ML components using compiler feedback that goes beyond simple binary success/fail signals. Implementations of the technique may incorporate specific error codes associated with different stages of the compiling process, as well as intensity levels indicating the relative impact of errors. In some implementations, the compiled source code itself may be used as input to the model in subsequent training iterations. As used herein, the term “compiler feedback” refers to any information generated during the compilation process that can be used to evaluate and improve the quality of generated source code, including but not limited to error messages, warnings, performance metrics, feedback signals, reward signals, error codes, error descriptions, and the compiled code itself.

In some implementations, the ML component may generate a first mapping object that includes EDI mapping source code. A compiler may perform a compiling operation to compile the first mapping object into a first compiled object. Based on the compiling operation, the compiler may generate a feedback signal that includes at least one compiler error and at least one data error. The feedback signal may indicate a feedback stage associated with the compiler error, allowing the system to pinpoint where in the compilation process issues arise. Additionally, the feedback signal may indicate an intensity level associated with the compiler error, enabling the system to prioritize more severe issues. As used herein, an “intensity level” refers to a measure of the severity or impact of an error, which may be represented numerically, categorically (e.g., low, medium, high), or through other suitable means.

Some implementations facilitate training an ML component by a reinforcement learning operation based on the first compiled object and the feedback signal. The trained ML component may be used to generate a second mapping object. This process may involve training the ML component to mitigate compiler errors according to a priority scheme, focusing on the most critical or frequent issues first. In some implementations, the ML component may include multiple specialized encoders, including an error encoder, a code encoder, an input encoder, and an output encoder. These encoders may process different aspects of the feedback and input data to generate context vectors, which may be combined and decoded to produce the improved mapping object. As used herein, a “context vector” refers to a mathematical representation of the semantic or contextual information extracted from a given input, which may be implemented as a fixed-length vector of real numbers. The system then outputs the second mapping object for execution by the map engine, resulting in improved EDI mapping. For example, the second mapping object may be compiled to generate a second compiled object, which may be used by the map engine to process EDI data.

This approach allows for more efficient learning processes and faster convergence to optimal code solutions. Furthermore, the ML component may include at least one encoder trained to process a specific code syntax associated with the mapping objects, enabling the development of additional tools such as code explanation tools or code search tools. These tools can further enhance the development process by providing insights into the generated code and facilitating the reuse of effective code patterns. As used herein, a “code explanation tool” refers to a software component that analyzes and provides human-readable descriptions of code functionality, while a “code search tool” refers to a component that enables efficient searching and retrieval of relevant code snippets based on specified criteria.

In some implementations, the system utilizes a novel technique for training machine learning components using compiler feedback that goes beyond simple binary success/fail signals. This technique incorporates specific error codes associated with different stages of the compiling process, intensity levels indicating the relative impact of errors, and provides the compiled source code itself as input to the model in subsequent training iterations. Accordingly, an advantage of the novel training technique is that it allows for more efficient learning processes by providing detailed and nuanced feedback to the machine learning component. Additionally, an advantage of the novel training technique is that it enables faster convergence to optimal code solutions by prioritizing the most critical or frequent issues based on error intensity levels.

In some implementations, the system generates a feedback signal comprising at least one compiler error or at least one data error, with the feedback signal indicating a feedback stage associated with the compiler error and an intensity level associated with the compiler error. Accordingly, an advantage of the feedback signal with associated stages and intensity levels is that it allows the system to pinpoint where in the compilation process issues arise, enabling more targeted improvements. Additionally, an advantage of the feedback signal with associated stages and intensity levels is that it enables the system to prioritize more severe issues, leading to more efficient error correction and overall improvement of the generated code.

In some implementations, the machine learning component comprises multiple specialized encoders, including an error encoder, a code encoder, an input encoder, and an output encoder, which process different aspects of the feedback and input data to generate context vectors. Accordingly, an advantage of the specialized encoders is that they allow for more focused and efficient processing of different types of input data, leading to more accurate and context-aware code generation. Additionally, an advantage of the specialized encoders is that they enable the development of additional tools such as code explanation tools or code search tools, which can further enhance the development process by providing insights into the generated code and facilitating the reuse of effective code patterns.

After the ML component is trained through the ML process, the ML component may be provided as an AI service, such as via a cloud computing service or the like. In such an embodiment, users may make use of the cloud-based AI service to generate source code for EDI translation or mapping. A user may send a source document, the MRS, and a destination document to the AI service, and the AI service may use the documents and the MRS to generate source code for EDI translation and send it back to the user for execution in their computing systems. The generated source code can be deployed on any bare metal server or a hybrid cloud cluster or on the user's desktop computers in order to perform the translation of source documents from a first format used by the sender, to a second format used by the recipient, and will do so in accordance with the rules and logic specified in the MRS. This allows users to generate EDI mappings or translations automatically, and automatically maintain the EDI infrastructure with minimum effort at a low cost.

In some illustrative embodiments, different instances of the trained ML component may be provided that are specific to the particular combination of source document format, destination document format, and MRS rules/logic. Thus, different instances of the ML component may be trained for different combinations of source document format, destination document format, and MRS rules/logic. Once an ML component is trained, modifications may be made to the MRS rules/logic and the ML component may be retrained based on these modifications to thereby implement the modified rules/logic in the source code output by the ML component. Similarly, modifications to the format of source document and destination document may likewise trigger a retraining of the ML component for those specific formats. Such retraining may be triggered periodically or in response to events, such as an update to the source document format, update to the destination document format, or update to the MRS.

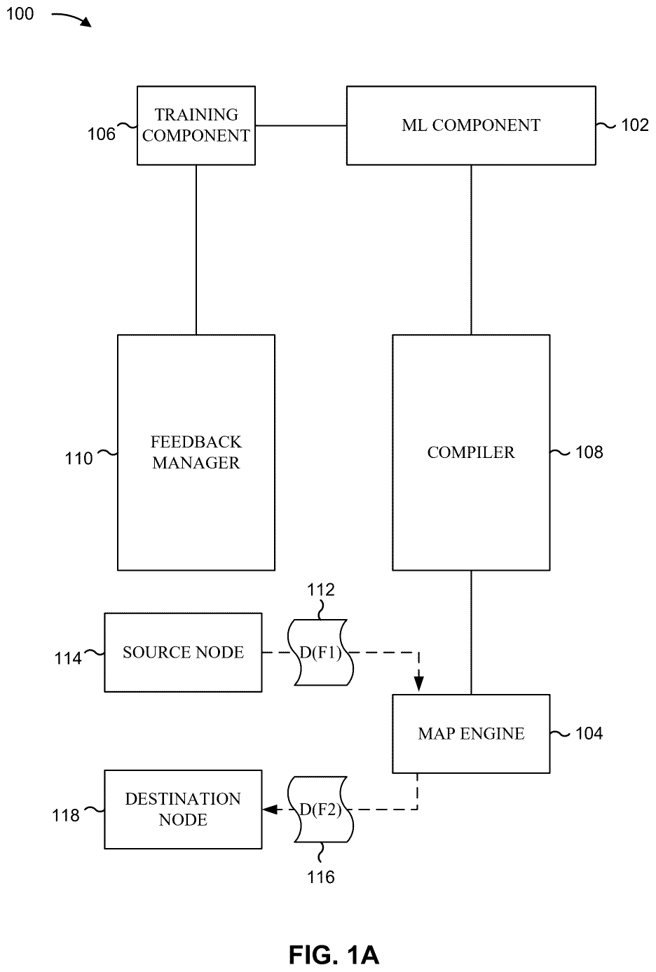

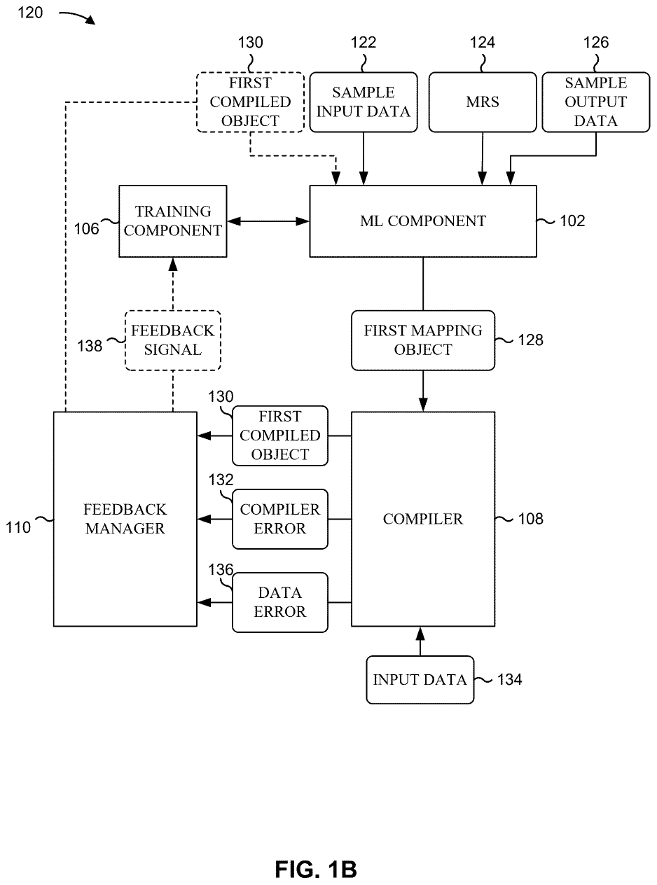

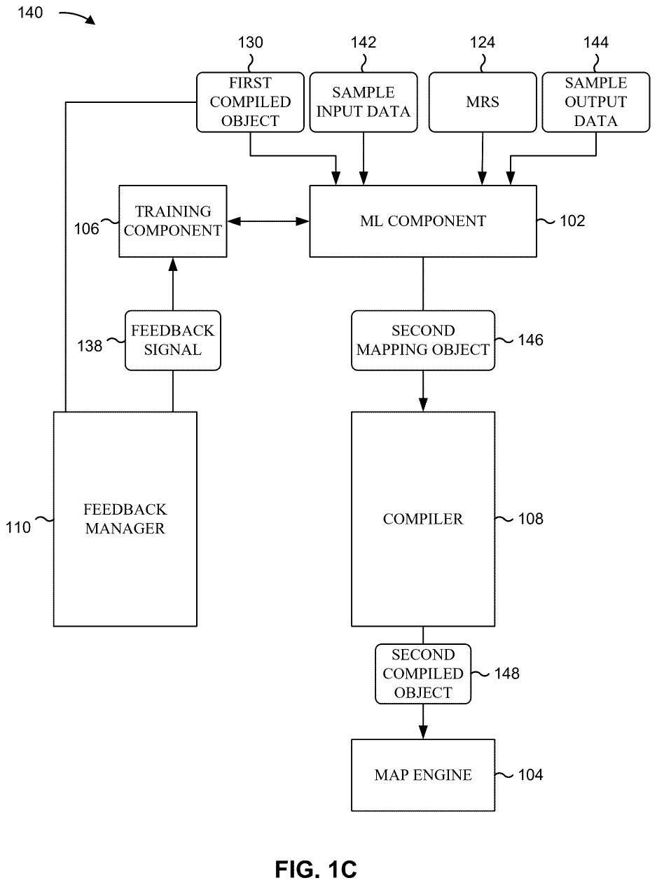

FIG. 1A is a block diagram of an example system 100 described herein. As shown in FIG. 1A, the system 100 includes an ML component 102, a map engine 104, a training component 106, a compiler 108, and a feedback manager 110. The ML component 102, the map engine 104, the training component 106, the compiler 108, and the feedback manager 110 can be configured to perform automated generation and maintenance of maps for EDI mapping, as well as automated source code generation. The training component 106 can be configured to generate a corpus based on the feedback signals from the feedback manager 110, where the corpus includes training dataset(s) for training the ML component 102.

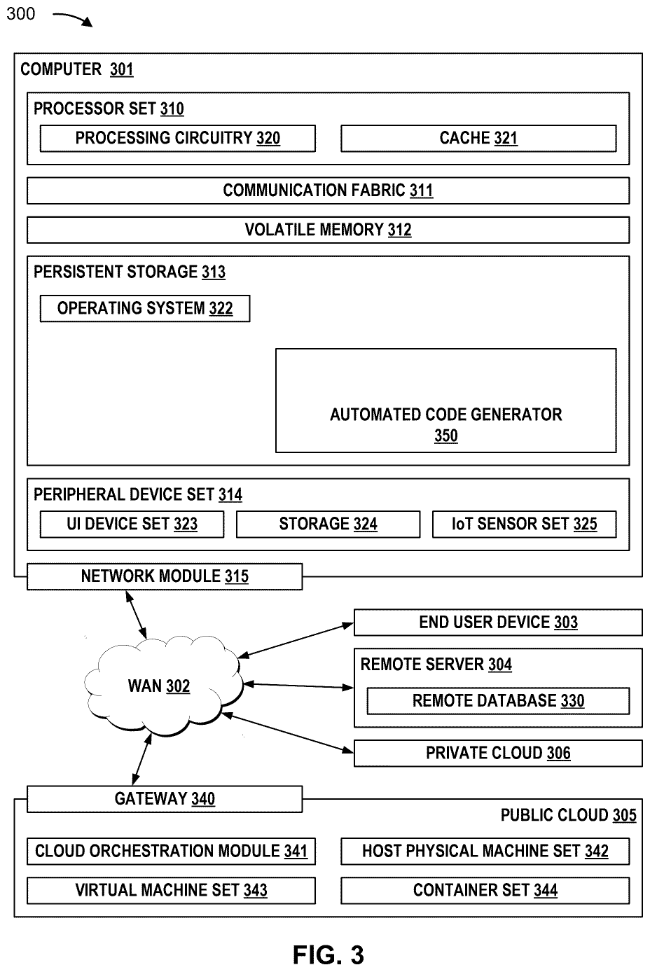

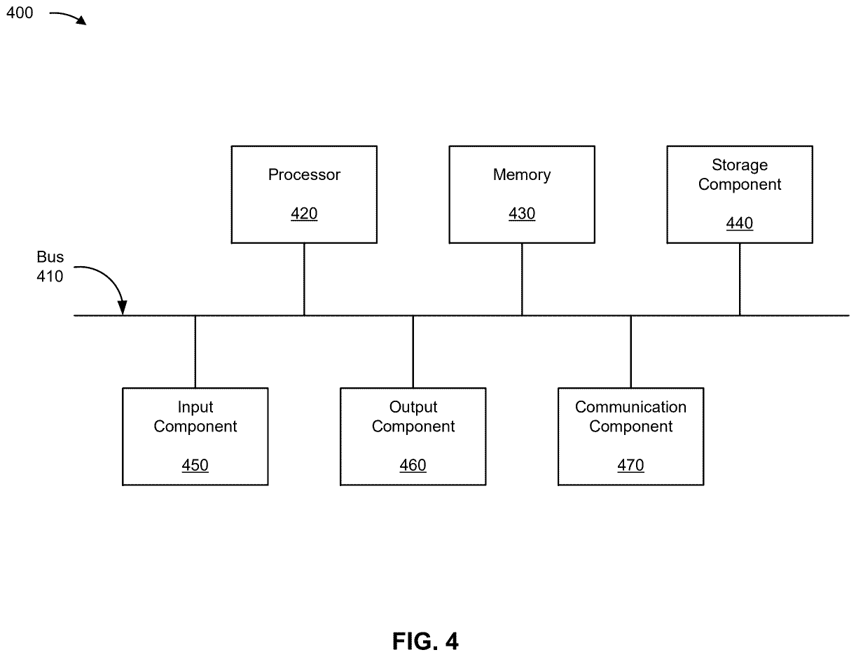

In some implementations, one or more of the ML component 102, the map engine 104, the training component 106, the compiler 108, and the feedback manager 110 can be or include a component of a cloud computing service (e.g., a cloud-based ML component). In some implementations, one or more of the ML component 102, the map engine 104, the training component 106, the compiler 108, and the feedback manager 110 can be or include a computing system or device including one or more processors and/or memory. For example, a computing device implementing one or more of the ML component 102, the map engine 104, the training component 106, the compiler 108, and the feedback manager 110 can be or can include a desktop computer, a laptop computer, a server computer, or the like. In some implementations, one or more of the ML component 102, the map engine 104, the training component 106, the compiler 108, and the feedback manager 110 can be or can include a virtual device implemented in a shared computing resource environment. For example, one or more of the ML component 102, the map engine 104, the training component 106, the compiler 108, and the feedback manager 110 can be implemented using the computing environment 300 described with respect to FIG. 3 and/or the device 400 described with respect to FIG. 4.

In some implementations, portions of the system 100 can be implemented on the same device. For example, the system 100 can be implemented as a platform as a service (PaaS) or the like, where the ML component 102, the map engine 104, the training component 106, the compiler 108, and the feedback manager 110 are all implemented on the same computing device. In some implementations, one or more of the ML component 102, the map engine 104, the training component 106, the compiler 108, and the feedback manager 110 can be implemented on different computing devices. For example, the ML component 102 can be implemented on a first computing device, the training component 106 can be implemented on a second computing device, and the map engine 104 and the compiler 108 can be implemented on a third computing device. In some implementations, one or more of the ML component 102, the map engine 104, the training component 106, the compiler 108, and the feedback manager 110 can be implemented as part of a cloud computing service that is remote from a device on which the feedback manager 110 is implemented. For example, one or more of the ML component 102, the map engine 104, the training component 106, the compiler 108, and the feedback manager 110 can be implemented as part of the computing environment 300 described with respect to FIG. 3 and/or the device 400 described with respect to FIG. 4.

For ease of discussion, but not to limit implementations or implementation, some features of the ML component 102, the map engine 104, the training component 106, the compiler 108, and the feedback manager 110 may be described in the context of a single one of the ML component 102, the map engine 104, the training component 106, the compiler 108, and the feedback manager 110. However, it should be understood that any or all of the features and functionality of the ML component 102, the map engine 104, the training component 106, the compiler 108, and the feedback manager 110 can be similarly implemented in a group of two or more of the ML component 102, the map engine 104, the training component 106, the compiler 108, and the feedback manager 110.

The ML component 102 may be configured for machine learning operations within the system 100 and may be implemented using various machine learning models such as neural networks, decision trees, or support vector machines. The training component 106 is used to train and refine the ML component 102, enabling it to improve its performance over time based on feedback and new data. The source code generated by the ML component 102 can be executed by the map engine 104 to map a source document 112 having a first format (shown as “F1”) from a source node 114 to a destination document 116 having a second format (shown as “F2”), which may be provided by a destination node 118.

The source document 112 and the destination document 116 can be EDI files, such as an X12 standard formatted document. Each of the source document 112 and the destination document 116 may be or otherwise include one or more EDI transactions files, such as X12 transactions files. The source node 114 is configured to provide (send or export) one or more EDI documents (e.g., the source document 112) to the system 100. The source node 114 can be or include any suitable source of EDI document such as a server or a client device. The destination node 118 is configured to receive (receive or import) one or more EDI documents (e.g., the destination document 116) from the system 100. The destination node 118 can be or include any suitable destination of EDI document, such as a server or a client device.

The compiler 108 may be configured to compile mapping objects generated by the ML component 102. This compilation process may involve translating high-level code into machine-readable instructions, optimizing the code for performance, and checking for syntax errors. The compiler 108 may support various programming languages and could be customized for specific EDI mapping requirements. The feedback manager 110 may be configured to process and manage feedback signals generated during the compilation and execution processes. For example, the feedback manager 110 may include a feedback encoder, which may be configured to generate a feedback signal comprising at least one compiler error or at least one data error. The feedback signal may indicate a feedback stage associated with the compiler error and an intensity level associated with the compiler error. The feedback signal may be provided with training dataset(s) to the training component 106 for training the ML component 102 to mitigate compiler errors according to a priority scheme, focusing on the most critical or frequent issues first.

FIGS. 1B and 1C illustrate an example of a process for automated code generation based on RLCF described herein. The process can be performed by a system associated with an ML component (such as the system 100 associated with the ML component 102). For example, the process can be performed by the system 100, such as by the ML component 102, the map engine 104, the training component 106, the compiler 108, and/or the feedback manager 110 described with respect to FIG. 1A.

FIG. 1B illustrates an operation of the system 100 during a first iteration 120 of the code generation process. In this iteration, the ML component 102 receives inputs including sample input data 122, an MRS 124, and sample output data 126. The sample input data 122 may include, for example, a sample source document such as the source document 112. The MRS 124 may specify the rules and logic involved in performing the translation from the source format to the destination format, (e.g., X12 to EDIFACT). The sample output data 126 may include, for example, a sample destination document such as the destination document 116.

The ML component 102 may generate a first mapping object 128 (which includes source code for the translation) and provide it to the compiler 108. The compiler 108 may perform a compiling operation to compile the first mapping object 128 into a first compiled object 130. Based on the compiling operation, the compiler 108 may generate compiler error 132, which may be reported to the feedback manager 110. In some implementations, the compiler 108 may perform a sophisticated multi-stage compiling operation, where the compiler 108 can compile the first mapping object 128 into the first compiled object 130 at one or more stages and report the compiler error 132 to the feedback manager 110 during any of the stages. For example, the compiler error 132 may indicate a particular compiling error that occurred during the compiling of the first mapping object 128, the stage of the compiling operation that caused the error, and the intensity level associated with the error. For example, the first compiled object 130 may include a compiled version of the sample source document corresponding to the source document 112 in an EDI mapping.

In some implementations, the compiler error 132 may be more than a binary reward signal. For example, rather than indicating a simple “success” or “failure,” the compiler error 132 may include an error code associated with an error occurring during compiling. The error code may indicate the nature of the error. For example, the compiler error 132 may indicate that the format of the compiled code does not match the format required by the destination node 118 (e.g., the EDIFACT format), or that the compiling operation took an excessive amount of time or computational resources. In this way, the compiler error 132 may indicate an error condition associated with the compiling operation that led to the generation of the first compiled object 130. The compiler error 132 also may indicate a compiling stage associated with the compiling operation that led to the generation of the first compiled object 130. Additionally, the compiler error 132 may indicate an intensity level of the compiling error, such as whether the compiling error was minor or severe. As noted above, the intensity level may be measured numerically, numerically categorical, or categorically.

In some implementations, the compiler may obtain input data 134 to use to execute the first compiled object 130 during the compilation process. For example, the input data 134 may include a sample source document corresponding to the source document 112 in an EDI mapping and/or a sample destination document corresponding to the destination document 116 in an EDI mapping. The compiler 108 may execute the first compiled object 130 based on the input data 134, which may result in a data error 136. The compiler 108 may report the data error to the feedback manager 110. In some implementations, the compiler 108 may perform a sophisticated multi-stage compiling operation, where the compiler 108 can compile the first compiled object 130 into an intermediate compiled object at one or more stages and report the data error 136 to the feedback manager 110 during any of the stages. For example, the data error 136 may indicate a particular compiling error that occurred during the compiling of the first compiled object 130, the stage of the compiling operation that caused the error, and the intensity level associated with the error.

The feedback manager 110 may generate a feedback signal 138 based on the compiler error 132 and/or the data error 136 and send the feedback signal 138 to the training component 106. The feedback signal 138 may indicate the compiler error 132 and/or the data error 136, and in some implementations, the feedback signal 138 may indicate the stage of the compiling operation that resulted in the compiler error 132 and/or the stage of the compiling operation that resulted in the data error 136. The feedback signal 138 may further indicate the intensity level associated with the compiler error 132 and/or the intensity level associated with the data error 136. As noted above, the intensity level may be measured numerically, numerically categorical, or categorically.

FIG. 1C illustrates an operation of the system 100 during a second iteration 140 of the code generation process. In this iteration, the ML component 102 may receive inputs including the feedback signal 138, the MRS 124, sample input data 142, and sample output data 144. The sample input data 142 may include, for example, a sample source document such as the source document 112. The MRS 124 may specify the rules and logic involved in performing the translation from the source format to the destination format, (e.g., X12 to EDIFACT). The sample output data 144 may include, for example, a sample destination document such as the destination document 116. In some implementations, the sample input data 142 and/or the sample output data 144 may be the same as the sample input data 122 and/or the sample output data 126, respectively. In some implementations, the sample input data 142 may be different from the sample input data 122, and/or the sample output data 144 may be different from the sample output data 126.

As shown, the first compiled object 130 is provided as an input to the ML component 102 along with the MRS 124. The training component 106 may use the feedback signal 138 to train the ML component 102 to mitigate compiler errors according to a priority scheme, focusing on the most critical or frequent issues first. The training component 106 may use the feedback signal 138 in an RLCF technique to generate a second mapping object 146 (which includes source code for the translation). The ML component 102 may send the second mapping object 146 to the compiler 108, which may compile the second mapping object 146 into a second compiled object 148. The second compiled object 148 may be provided to the map engine 104, which may perform a mapping operation based on the second compiled object 148 and thereby generate a mapping 156 for the automated generation and maintenance of EDI mapping.

In some implementations, the training component 106 may perform any number of iterations to train the ML component 102. In this way, the ML component 102 may learn a correlation between input patterns of text in the respective ones of the sample input data 142, the sample source document, and the sample output data 144, and corresponding output features (e.g., the second mapping object 146).

This iterative process is configured to address the technical challenge of creating and maintaining accurate EDI mappings by continuously refining mapping rules based on real-world data and feedback. The system's ability to learn and adapt over time may facilitate several improvements over traditional manual mapping approaches. For instance, the system is configured to increase accuracy by learning from errors and feedback, enabling the production of more accurate mappings over time and potentially reducing the risk of data transformation errors. Additionally, the automated nature of the system may facilitate improved efficiency by significantly reducing the time and effort required to create and maintain EDI mappings, addressing the technical problem of resource-intensive manual mapping processes.

Furthermore, the system is configured to adapt quickly to changes in data formats or mapping requirements, thereby addressing the technical challenge of maintaining mappings in dynamic business environments. The automated learning process may also facilitate scalability by enabling the system to handle a large number of mapping scenarios, providing a solution for managing the complexity of EDI environments. Finally, by utilizing a standardized, machine learning-based approach, the system ensures consistent mapping rules across various scenarios, which may reduce the risk of human error and enhance uniformity. Together, these features are configured to overcome significant technical challenges associated with traditional EDI mapping methodologies.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

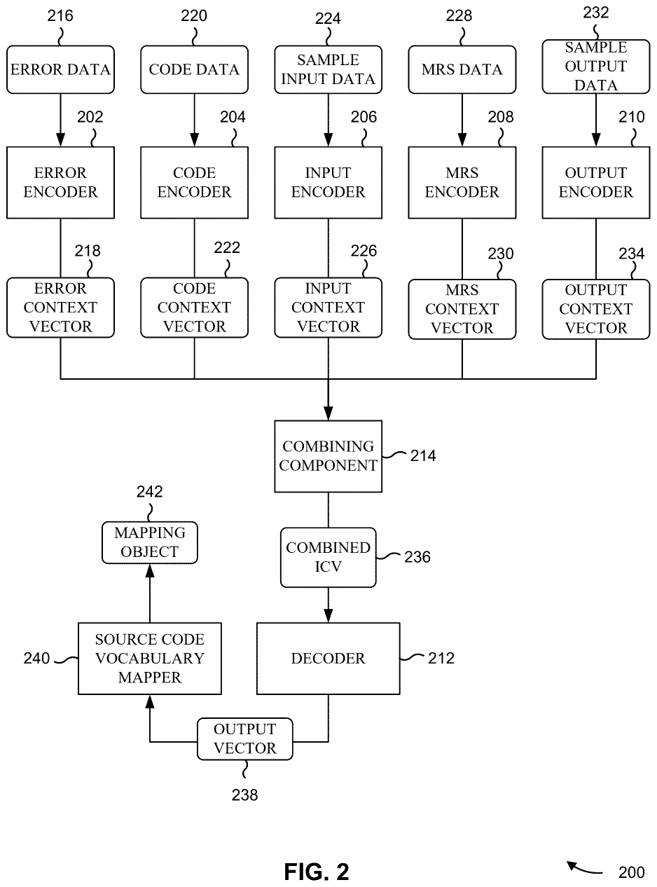

FIG. 2 is a schematic block diagram showing an example 200 of an implementation associated with automated code generation based on RLCF described herein. The implementation 200 may be implemented using the system 100 such as the ML component 102, the map engine 104, the training component 106, the compiler 108, and the feedback manager 110 described with respect to FIG. 1A.

The implementation 200 includes multiple encoders, a combining component, a decoder, and a source code vocabulary mapper. As shown, for example, the implementation 200 includes five specialized encoders: an error encoder 202, a code encoder 204, an input encoder 206, an MRS encoder 208, and an output encoder 210. Each encoder is designed to process specific types of input data and generate corresponding context vectors.

The error encoder 202 is configured to receive error data 216 and produce an error context vector 218. The error data 216 may include one or more of error codes, error messages, or error descriptions. For example, the error data 216 may be, or be similar to, the feedback signal 138 or compiler error(s) 132 and/or data error(s) 136 described with respect to FIGS. 1B-1C.

The error encoder 202 may process the error data 216 and produce the error context vector 218, which may be a mathematical representation of the semantic or contextual information extracted from the error data 216.

The code encoder 204 is configured to receive code data 220 and produce a code context vector 222. The code data 220 may include one a compiled output. For example, the code data 220 may be, or be similar to, the compiled object 130 or the compiled object 148 described with respect to FIGS. 1B-1C. In some implementations, the code encoder 204 may receive code data 220 such as source code, code syntax, code instructions, code annotations, or the like. The code context vector 222 may be a mathematical representation of the semantic or contextual information extracted from the code data 220.

The input encoder 206 is configured to receive input data 224 and produce an input context vector 226. The input data 224 may include, for example, a source document or a destination document in an EDI mapping. The input encoder 206 may process the input data 224 and produce the input context vector 226, which may be a mathematical representation of the semantic or contextual information extracted from the input data 224.

The MRS encoder 208 is configured to receive MRS data 228 and produce an MRS context vector 230. The MRS data 228 may include one or more of the rules and/or logic associated with the EDI mapping. In some implementations, the MRS data 228 may further include a matrix of weight values representing weights based on the rules and/or logic. The MRS encoder 208 may process the MRS data 228 and produce the MRS context vector 230, which may be a mathematical representation of the semantic or contextual information extracted from the MRS data 228.

The output encoder 210 is configured to receive output data 232 and produce an output context vector 234. The output data 232 may include, for example, a compiled output. For example, the output data 232 may be, or be similar to, the first compiled object 130 or the second compiled object 148 described with respect to FIGS. 1B-1C. The output encoder 210 may process the output data 232 and produce the output context vector 234, which may be a mathematical representation of the semantic or contextual information extracted from the output data 232.

The context vectors produced by the error encoder 202, the code encoder 204, the input encoder 206, the MRS encoder 208, and the output encoder 210 may be combined at a combining component 214 to generate an in-context vector (ICV) 236. The combined ICV 236 may be a mathematical representation of the semantic or contextual information extracted from the error context vector 218, the code context vector 222, the input context vector 226, the MRS context vector 230, and the output context vector 234. The combining component 214 may combine the different context vectors via any suitable technique, including concatenation, summation, and/or one or more mathematical operations, such as addition or multiplication.

The ICV 236 may be fed to a decoder 212. The decoder 212 may be configured to process the ICV 236 to produce an output vector 238. The output vector 238 may be processed by a source code vocabulary mapper 240 to produce a mapping object 242. The mapping object 242 may include, for example, source code for translation from a source format to a destination format. For example, the mapping object 242 may be, or be similar to, the second mapping object 146 described with respect to FIGS. 1B-1C.

Although not illustrated in FIG. 2, the implementation 200 may include a set of max pooling layers and a set of output layers. For example, the output of each of the encoders (e.g., the error encoder 202, the code encoder 204, the input encoder 206, the MRS encoder 208, and the output encoder 210) may be processed by a corresponding one of the max pooling layers. The output of each of the max pooling layers may then be processed by a corresponding one of the output layers, which may produce an output to the decoder 212. In some implementations, the max pooling layers operate to down-sample each of the context vectors in the encoders (e.g., the error encoder 202, the code encoder 204, the input encoder 206, the MRS encoder 208, and the output encoder 210) to produce a lower resolution output. In some implementations, the max pooling layers may generate pooled feature maps that capture the important/local information. The output layers may operate to generate and output the context vectors (e.g., the error context vector 218, the code context vector 222, the input context vector 226, the MRS context vector 230, and the output context vector 234), which may be referred to as embedding vectors. The decoder 212 may use the embedding vectors to identify the source code features, such as syntax, grammar, variables, and/or the like.

In some implementations, each of the encoders may be a stack of recurrent neural network(s) (RNNs), long short-term memory (LSTM) networks, or gated recurrent unit (GRU) network(s) that can learn temporal correlation within input data. The decoder 212 may also be a stack of RNNs, LSTM networks, or GRU networks in which each unit (such as a node or the like) predicts an output in the source code sequence. In some implementations, for example, each recurrent unit in the decoder 212 may be configured to accept a hidden state from a previous unit and produce an output as well as a new hidden state. The output sequence may be a collection of source code snippets, each source code snippet including one or more source code terms, instructions, or the like, for defining executable source code. The source code may be specifically designed to map or translate between the source data and the destination data in their respective formats. In some implementations, the source code generated by the decoder 212 may be an open source code that is not tied to a specific EDI tool.

As indicated above, FIG. 2 is provided as an example. Other examples may differ from what is described with regard to FIG. 2. The number and arrangement of devices shown in FIG. 2 are provided as an example. A network, formed by the devices shown in FIG. 2 may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

For example, there may be additional components (e.g., additional encoders, decoders, layers, etc.), fewer components, different components, or differently arranged components than those shown in FIG. 2. Furthermore, two or more components shown in FIG. 2 may be implemented within a single component, or a single components shown in FIG. 2 may be implemented as multiple, distributed components. Additionally, or alternatively, a set of components (e.g., one or more components) shown in FIG. 2 may perform one or more functions described as being performed by another set of components shown in Figs. FIG. 2.

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as an automated feedback-enhanced EDI mapping source code generator, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

FIG. 4 is a diagram of example components of a device 400, which may implement one or more components of the system 100. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

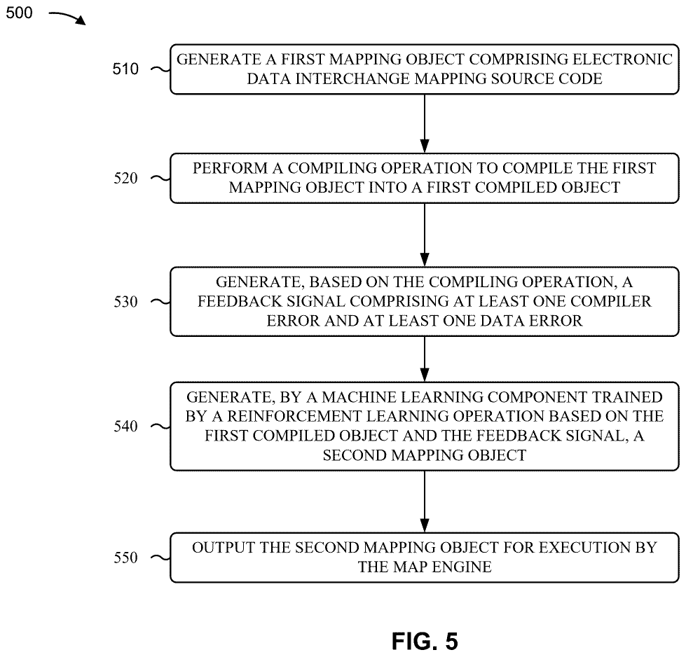

FIG. 5 is a flowchart of an example process 500 associated with automated code generation based on reinforcement learning with compiler feedback as described herein. In some implementations, one or more process blocks of FIG. 5 may be performed by a system (e.g., system 100 or one or more components thereof). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include generating a first mapping object comprising electronic data interchange mapping source code (block 510). For example, the system may generate a first mapping object comprising electronic data interchange mapping source code, as described above.

As further shown in FIG. 5, process 500 may include performing a compiling operation to compile the first mapping object into a first compiled object (block 520). For example, the system may perform a compiling operation to compile the first mapping object into a first compiled object, as described above.

As further shown in FIG. 5, process 500 may include generating, based on the compiling operation, a feedback signal comprising at least one compiler error or at least one data error (block 530). For example, the system may generate, based on the compiling operation, a feedback signal comprising at least one compiler error or at least one data error, as described above. In some implementations, the feedback signal may indicate a feedback stage associated with the compiler error. In some implementations, the feedback signal may indicate an intensity level associated with the compiler error.

In some implementations, the at least one compiler error may include a plurality of compiler errors. The feedback signal may indicate, for each compiler error of the plurality of compiler errors, a corresponding feedback stage and an associated intensity level. The at least one compiler error may include an error code of a set three or more error codes.

In some implementations, performing the compiling operation may include compiling the first mapping object into the first compiled object; obtaining a set of input data; and executing the first compiled object based on the input data, where the data error includes a dynamic data error associated with the executing the first compiled object.

As further shown in FIG. 5, process 500 may include generating, by a machine learning component trained by a reinforcement learning operation based on the first compiled object and the feedback signal, a second mapping object (block 540). For example, the system may generate, by a machine learning component trained by a reinforcement learning operation based on the first compiled object and the feedback signal, a second mapping object, as described above.

In some implementations, the at least one compiler error may include a plurality of compiler errors and, generating the second mapping object may include training the machine learning component to mitigate compiler errors of the plurality of compiler errors according to a priority scheme.

In some implementations, generating the second mapping object may include providing error data, based on the feedback signal, to an error encoder of the machine learning component to generate an error context vector; providing code data, based on the feedback signal, to a code encoder of the machine learning component to generate a code context vector; providing sample input data to an input encoder of the machine learning component to generate an input context vector; providing sample output data to an output encoder of the machine learning component to generate an output context vector; combining the error context vector, the code context vector, the input context vector, and the output context vector into a combined in-context vector; and providing the combined in-context vector to a decoder of the machine learning component to generate the second mapping object. The machine learning component may include at least one encoder trained to process a code syntax associated with the first and second mapping objects.

As further shown in FIG. 5, process 500 may include outputting the second mapping object for execution by the map engine (block 550). For example, the system may output the second mapping object for execution by a map engine, as described above. In some implementations, the process 500 may include generating, based on the at least one encoder, at least one of a code explanation tool or a code search tool.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

According to an aspect of the disclosure, there is provided a computer system comprising a processor set, one or more computer-readable storage media, and program instructions stored on the one or more computer-readable storage media. The program instructions cause the processor set to perform operations. These operations include generating a first mapping object comprising electronic data interchange mapping source code, performing a compiling operation to compile the first mapping object into a first compiled object, generating a feedback signal based on the compiling operation, generating, by a machine learning component trained by a reinforcement learning operation based on the first compiled object and the feedback signal, a second mapping object, and outputting the second mapping object for execution by a map engine. The feedback signal comprises at least one compiler error and at least one data error. The reinforcement learning operation is associated with a machine learning component and is based on the first compiled object and the feedback signal. This system has the technical effect of improving the accuracy and efficiency of electronic data interchange mapping through iterative refinement based on compiler feedback. Additionally, the use of reinforcement learning allows the system to adapt and improve its mapping capabilities over time, potentially reducing the need for manual intervention in the mapping process.

In embodiments, the feedback signal indicates a feedback stage associated with the compiler error. This feature has the technical effect of providing more granular information about where in the compilation process errors occur, allowing for more targeted improvements in subsequent iterations. Additionally, this feature can help prioritize which errors to address first, potentially speeding up the overall optimization process.

In embodiments, the feedback signal indicates an intensity level associated with the compiler error. This feature has the technical effect of quantifying the severity or impact of each error, enabling the system to focus on resolving the most critical issues first. Additionally, this feature can help in allocating computational resources more efficiently during the reinforcement learning process.

In embodiments, the at least one compiler error comprises a plurality of compiler errors. This feature has the technical effect of providing a more comprehensive view of the issues present in the mapping object, allowing for a more thorough optimization process. Additionally, addressing multiple errors simultaneously can lead to more efficient improvements in the mapping object.

In embodiments, the feedback signal indicates, for each compiler error of the plurality of compiler errors, a corresponding feedback stage and an associated intensity level. This feature has the technical effect of providing a detailed error profile for each compilation attempt, enabling more sophisticated error analysis and prioritization. Additionally, this comprehensive feedback can lead to more targeted and effective improvements in subsequent iterations.

In embodiments, the at least one compiler error comprises an error code of a set of three or more error codes. This feature has the technical effect of providing more specific and categorized information about the types of errors encountered, facilitating more precise error handling and resolution strategies. Additionally, a larger set of error codes can enable more nuanced feedback to the reinforcement learning process.

In embodiments, performing the compiling operation can comprise compiling the first mapping object into the first compiled object, obtaining a set of input data, and executing the first compiled object based on the input data. The data error can comprise a dynamic data error associated with executing the first compiled object. This feature has the technical effect of identifying runtime errors in addition to compilation errors, providing a more comprehensive assessment of the mapping object's performance. Additionally, this can help in creating more robust and reliable mapping objects that perform well with actual data inputs.

In embodiments, generating the second mapping object can comprise training the machine learning component to mitigate compiler errors of the plurality of compiler errors according to a priority scheme. This feature has the technical effect of focusing the optimization process on the most important or impactful errors first, potentially leading to faster overall improvement of the mapping object. Additionally, this prioritized approach can help in making more efficient use of computational resources during the reinforcement learning process.

In embodiments, generating the second mapping object can comprise providing error data, code data, sample input data, and sample output data to respective encoders of the machine learning component to generate context vectors, combining these context vectors into a combined in-context vector, and providing the combined in-context vector to a decoder of the machine learning component to generate the second mapping object. This feature has the technical effect of enabling the machine learning component to consider multiple types of information simultaneously when generating improved mapping objects. Additionally, this approach can lead to more holistic and context-aware improvements in the mapping process.

In embodiments, the machine learning component can comprise at least one encoder trained to process a code syntax associated with the first and second mapping objects. This feature has the technical effect of enabling the system to understand and work with specific code syntaxes more effectively, potentially leading to more accurate and efficient mapping object generation. Additionally, this specialized encoding can facilitate better error detection and correction in the context of the specific code syntax being used.

In embodiments, the operations can further comprise generating, based on the at least one encoder, at least one of a code explanation tool or a code search tool. This feature has the technical effect of providing additional utilities that can aid in understanding and working with the generated mapping objects. A code explanation tool can help users understand the logic behind the generated mappings, while a code search tool can facilitate finding specific code patterns or structures within the mapping objects. Additionally, these tools can enhance the overall usability and maintainability of the system.

According to an aspect of the disclosure, there is provided a computer-implemented method comprising generating a first mapping object comprising electronic data interchange mapping source code, performing a compiling operation to compile the first mapping object into a first compiled object, generating a feedback signal based on the compiling operation, generating, by a machine learning component trained by a reinforcement learning operation based on the first compiled object and the feedback signal, a second mapping object, and outputting the second mapping object for execution by a map engine. The feedback signal comprises at least one compiler error and at least one data error. The reinforcement learning operation is associated with a machine learning component and is based on the first compiled object and the feedback signal. This method has the technical effect of iteratively improving electronic data interchange mapping through a feedback-driven machine learning process. Additionally, this approach can lead to more efficient and accurate mapping processes over time, reducing the need for manual intervention and potentially improving the overall performance of electronic data interchange systems.

In embodiments, the at least one compiler error can comprise a plurality of compiler errors, and the feedback signal can indicate, for each compiler error of the plurality of compiler errors, a corresponding feedback stage and an associated intensity level. This feature has the technical effect of providing detailed and structured feedback about multiple errors, enabling more sophisticated error analysis and prioritization in the reinforcement learning process. Additionally, this comprehensive feedback can lead to more targeted and effective improvements in subsequent iterations of the mapping object.

In embodiments, the at least one compiler error can comprise an error code of a set of three or more error codes. This feature has the technical effect of providing more specific and categorized information about the types of errors encountered, facilitating more precise error handling and resolution strategies. Additionally, a larger set of error codes can enable more nuanced feedback to the reinforcement learning process, potentially leading to more effective improvements in the mapping objects.

In embodiments, performing the compiling operation can comprise compiling the first mapping object into the first compiled object, obtaining a set of input data, and executing the first compiled object based on the input data. The data error can comprise a dynamic data error associated with executing the first compiled object. This feature has the technical effect of identifying runtime errors in addition to compilation errors, providing a more comprehensive assessment of the mapping object's performance. Additionally, this can help in creating more robust and reliable mapping objects that perform well with actual data inputs.

In embodiments, generating the second mapping object can comprise training the machine learning component to mitigate compiler errors of the plurality of compiler errors according to a priority scheme. This feature has the technical effect of focusing the optimization process on the most important or impactful errors first, potentially leading to faster overall improvement of the mapping object. Additionally, this prioritized approach can help in making more efficient use of computational resources during the reinforcement learning process.

According to an aspect of the disclosure, there is provided a computer program product comprising one or more computer-readable storage media and program instructions stored on the one or more computer-readable storage media. The program instructions, when executed, perform operations comprising generating a first mapping object comprising electronic data interchange mapping source code, performing a compiling operation to compile the first mapping object into a first compiled object, generating a feedback signal based on the compiling operation, generating, by a machine learning component trained by a reinforcement learning operation based on the first compiled object and the feedback signal, a second mapping object, and outputting the second mapping object for execution by a map engine. The feedback signal comprises at least one compiler error and at least one data error. The reinforcement learning operation is associated with a machine learning component and is based on the first compiled object and the feedback signal. This computer program product has the technical effect of enabling automated and iterative improvement of electronic data interchange mapping through software-based reinforcement learning. Additionally, this approach can lead to more efficient and accurate mapping processes over time, potentially improving the overall performance and reliability of electronic data interchange systems.

In embodiments, generating the second mapping object can comprise providing error data, code data, sample input data, and sample output data to respective encoders of the machine learning component to generate context vectors, combining these context vectors into a combined in-context vector, and providing the combined in-context vector to a decoder of the machine learning component to generate the second mapping object. This feature has the technical effect of enabling the machine learning component to consider multiple types of information simultaneously when generating improved mapping objects. Additionally, this approach can lead to more holistic and context-aware improvements in the mapping process, potentially resulting in more robust and effective mapping objects.

In embodiments, the machine learning component can comprise at least one encoder trained to process a code syntax associated with the first and second mapping objects. This feature has the technical effect of enabling the system to understand and work with specific code syntaxes more effectively, potentially leading to more accurate and efficient mapping object generation. Additionally, this specialized encoding can facilitate better error detection and correction in the context of the specific code syntax being used.

In embodiments, the operations can further comprise generating, based on the at least one encoder, at least one of a code explanation tool or a code search tool. This feature has the technical effect of providing additional utilities that can aid in understanding and working with the generated mapping objects. A code explanation tool can help users understand the logic behind the generated mappings, while a code search tool can facilitate finding specific code patterns or structures within the mapping objects. Additionally, these tools can enhance the overall usability and maintainability of the system, potentially improving the efficiency of developers and users working with the mapping objects.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. The feedback signal indicates, for each compiler error of a plurality of compiler errors, a corresponding feedback stage and an associated intensity level. This system has the technical effect of providing detailed and structured feedback about multiple errors, enabling more sophisticated error analysis and prioritization in the reinforcement learning process. Additionally, this approach can lead to more targeted and effective improvements in subsequent iterations of the mapping object.

Additionally or alternatively, an embodiment in which the feedback signal includes, for each compiler error of a plurality of compiler errors, a corresponding feedback stage and an associated intensity level, has the technical effect of enabling fine-grained error tracking and prioritization. This can lead to more efficient error resolution and faster convergence in the reinforcement learning process.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. The at least one compiler error comprises an error code of a set of three or more error codes. This system has the technical effect of providing more specific and categorized information about the types of errors encountered, facilitating more precise error handling and resolution strategies. Additionally, this approach can enable more nuanced feedback to the reinforcement learning process, potentially leading to more effective improvements in the mapping objects.

Additionally or alternatively, an embodiment in which the at least one compiler error includes an error code of a set of three or more error codes has the technical effect of enabling more precise error categorization and handling. This can lead to more targeted error resolution strategies and potentially faster improvement of the mapping objects.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. The feedback signal indicates, for each compiler error of a plurality of compiler errors, a corresponding feedback stage and an associated intensity level. The at least one compiler error comprises an error code of a set of three or more error codes. This system has the technical effect of providing highly detailed and categorized error information, enabling sophisticated error analysis, prioritization, and resolution strategies. Additionally, this approach can lead to more efficient and targeted improvements in the mapping objects through the reinforcement learning process.

Additionally or alternatively, an embodiment in which the feedback signal indicates, for each compiler error of a plurality of compiler errors, a corresponding feedback stage and an associated intensity level, and the at least one compiler error comprises an error code of a set of three or more error codes, has the technical effect of enabling highly granular error tracking, categorization, and prioritization. This can lead to more efficient error resolution, faster convergence in the reinforcement learning process, and more effective improvements in the mapping objects.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. Performing the compiling operation comprises: compiling the first mapping object into the first compiled object; obtaining a set of input data; and executing the first compiled object based on the input data, where the data error comprises a dynamic data error associated with executing the first compiled object. This system has the technical effect of identifying runtime errors in addition to compilation errors, providing a more comprehensive assessment of the mapping object's performance. Additionally, this approach can help in creating more robust and reliable mapping objects that perform well with actual data inputs.

Additionally or alternatively, an embodiment in which performing the compiling operation includes compiling the first mapping object into the first compiled object, obtaining a set of input data, and executing the first compiled object based on the input data, where the data error comprises a dynamic data error associated with executing the first compiled object, has the technical effect of enabling detection of runtime errors in addition to compilation errors. This can lead to the creation of more robust and reliable mapping objects that perform well under real-world conditions.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. The at least one compiler error comprises a plurality of compiler errors and generating the second mapping object comprises training the machine learning component to mitigate compiler errors of the plurality of compiler errors according to a priority scheme. This system has the technical effect of focusing the optimization process on the most important or impactful errors first, potentially leading to faster overall improvement of the mapping object. Additionally, this prioritized approach can help in making more efficient use of computational resources during the reinforcement learning process.

Additionally or alternatively, an embodiment in which the at least one compiler error comprises a plurality of compiler errors and generating the second mapping object comprises training the machine learning component to mitigate compiler errors of the plurality of compiler errors according to a priority scheme has the technical effect of enabling more efficient error resolution by focusing on the most critical errors first. This can lead to faster overall improvement of the mapping object and more efficient use of computational resources during the reinforcement learning process.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. The feedback signal indicates, for each compiler error of a plurality of compiler errors, a corresponding feedback stage and an associated intensity level. The at least one compiler error comprises an error code of a set of three or more error codes. The at least one compiler error comprises a plurality of compiler errors and generating the second mapping object comprises training the machine learning component to mitigate compiler errors of the plurality of compiler errors according to a priority scheme. This system has the technical effect of providing highly detailed error information, enabling sophisticated error analysis, prioritization, and resolution strategies, while also focusing the optimization process on the most important errors first. Additionally, this approach can lead to more efficient and targeted improvements in the mapping objects through the reinforcement learning process, potentially accelerating overall system performance.

Additionally or alternatively, an embodiment in which the feedback signal indicates, for each compiler error of a plurality of compiler errors, a corresponding feedback stage and an associated intensity level, the at least one compiler error comprises an error code of a set of three or more error codes, and generating the second mapping object comprises training the machine learning component to mitigate compiler errors of the plurality of compiler errors according to a priority scheme, has the technical effect of enabling highly granular error tracking, categorization, and prioritization, while also focusing on resolving the most critical errors first. This can lead to more efficient error resolution, faster convergence in the reinforcement learning process, and more effective improvements in the mapping objects, potentially resulting in accelerated overall system performance.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. Generating the second mapping object comprises: providing error data, based on the feedback signal, to an error encoder of the machine learning component to generate an error context vector; providing code data, based on the feedback signal, to a code encoder of the machine learning component to generate a code context vector; providing sample input data to an input encoder of the machine learning component to generate an input context vector; providing sample output data to an output encoder of the machine learning component to generate an output context vector; combining the error context vector, the code context vector, the input context vector, and the output context vector into a combined in-context vector; and providing the combined in-context vector to a decoder of the machine learning component to generate the second mapping object. This system has the technical effect of enabling the machine learning component to consider multiple types of information simultaneously when generating improved mapping objects. Additionally, this approach can lead to more holistic and context-aware improvements in the mapping process, potentially resulting in more robust and effective mapping objects.

Additionally or alternatively, an embodiment in which generating the second mapping object comprises providing various types of data to different encoders to generate context vectors, combining these vectors, and providing the combined vector to a decoder has the technical effect of enabling the machine learning component to process and integrate multiple types of information simultaneously. This can lead to more comprehensive and context-aware improvements in the mapping process, potentially resulting in more robust and effective mapping objects.

According to an aspect of the disclosure, there is provided a computer system comprising a processor set, one or more computer-readable storage media, and program instructions stored on the one or more computer-readable storage media. The program instructions cause the processor set to perform operations comprising: generating a first mapping object comprising electronic data interchange mapping source code; performing a compiling operation to compile the first mapping object into a first compiled object; generating, based on the compiling operation, a feedback signal comprising at least one compiler error or at least one data error; generating, by a reinforcement learning operation associated with a machine learning component and based on the first compiled object and the feedback signal, a second mapping object; and outputting the second mapping object for execution by a map engine. The machine learning component comprises at least one encoder trained to process a code syntax associated with the first and second mapping objects. The operations further comprise generating, based on the at least one encoder, at least one of a code explanation tool or a code search tool. This system has the technical effect of enabling the system to understand and work with specific code syntaxes more effectively, potentially leading to more accurate and efficient mapping object generation. Additionally, the generation of code explanation or search tools can enhance the overall usability and maintainability of the system, potentially improving the efficiency of developers and users working with the mapping objects.

Additionally or alternatively, an embodiment in which the machine learning component comprises at least one encoder trained to process a code syntax associated with the first and second mapping objects, and the operations further comprise generating, based on the at least one encoder, at least one of a code explanation tool or a code search tool, has the technical effect of enabling more effective processing of specific code syntaxes and providing additional tools for working with the generated code. This can lead to more accurate and efficient mapping object generation, as well as improved usability and maintainability of the system, potentially enhancing the productivity of developers and users working with the mapping objects.

The system described herein can be particularly useful in the context of electronic data interchange (EDI) mapping for business-to-business (B2B) transactions. For example, consider a scenario where a large automobile manufacturer needs to exchange purchase order documents with thousands of suppliers, each potentially using different document formats. The system can automatically generate and refine mapping objects to translate between the manufacturer's internal format (e.g., an X12 standard formatted document) and the various formats used by suppliers (e.g., EDIFACT, VDA, or proprietary formats).

In this use case, the machine learning component would initially generate a first mapping object based on sample input data (e.g., an X12 purchase order), sample output data (e.g., an EDIFACT purchase order), and mapping rules specified in the MRS. The compiler would then attempt to compile this mapping object. If errors occur during compilation or execution with test data, the system would generate a detailed feedback signal. This feedback signal might indicate, for instance, that there are multiple syntax errors in the generated code (compiler errors) and that certain required fields are missing in the output document (data errors).

The reinforcement learning operation would then use this feedback to generate an improved second mapping object. For example, it might prioritize fixing the syntax errors first, then address the missing fields. The system would iterate through this process, continuously refining the mapping object until it successfully compiles and produces correct output documents. This automated process can significantly reduce the time and effort required to create and maintain EDI mappings, potentially saving thousands of development hours across the manufacturer's B2B integration efforts.

Furthermore, the code explanation tool generated by the system could help the manufacturer's IT team understand the logic behind the automatically generated mappings. This could be particularly valuable when troubleshooting complex transformations or when regulations require auditable documentation of data handling processes. The code search tool, on the other hand, could assist in quickly locating specific mapping logic across thousands of trading partner integrations, facilitating rapid updates when document standards or business requirements change.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
generating a first mapping object comprising electronic data interchange mapping
source code;
performing a compiling operation to compile the first mapping object into a first compiled object;
generating, based on the compiling operation, a feedback signal comprising at least one compiler error or at least one data error;
generating, by a machine learning component trained by a reinforcement learning operation based on the first compiled object and the feedback signal, a second mapping object; and
outputting the second mapping object for execution by a map engine.

2. The computer system of claim 1, wherein the feedback signal indicates a feedback stage associated with the compiler error.

3. The computer system of claim 1, wherein the feedback signal indicates an intensity level associated with the compiler error.

4. The computer system of claim 1, wherein the at least one compiler error comprises a plurality of compiler errors.

5. The computer system of claim 4, wherein the feedback signal indicates, for each compiler error of the plurality of compiler errors, a corresponding feedback stage and an associated intensity level.

6. The computer system of claim 1, wherein the at least one compiler error comprises an error code of a set of three or more error codes.

7. The computer system of claim 1, wherein performing the compiling operation comprises:
compiling the first mapping object into the first compiled object;
obtaining a set of input data; and
executing the first compiled object based on the input data, wherein the data error comprises a dynamic data error associated with the executing the first compiled object.

8. The computer system of claim 1, wherein the at least one compiler error comprises a plurality of compiler errors and wherein, generating the second mapping object comprises:
training the machine learning component to mitigate compiler errors of the plurality of compiler errors according to a priority scheme.

9. The computer system of claim 1, wherein generating the second mapping object comprises:
providing error data, based on the feedback signal, to an error encoder of the machine learning component to generate an error context vector;
providing code data, based on the feedback signal, to a code encoder of the machine learning component to generate a code context vector;
providing sample input data to an input encoder of the machine learning component to generate an input context vector;
providing sample output data to an output encoder of the machine learning component to generate an output context vector;
combining the error context vector, the code context vector, the input context vector, and the output context vector into a combined in-context vector; and
providing the combined in-context vector to a decoder of the machine learning component to generate the second mapping object.

10. The computer system of claim 1, wherein the machine learning component comprises at least one encoder trained to process a code syntax associated with the first and second mapping objects.

11. The computer system of claim 10, the operations further comprising generating, based on the at least one encoder, at least one of a code explanation tool or a code search tool.

12. A computer-implemented method, comprising:
generating a first mapping object comprising electronic data interchange mapping source code;
performing a compiling operation to compile the first mapping object into a first compiled object;
generating, based on the compiling operation, a feedback signal comprising at least one compiler error or at least one data error;
generating, by a machine learning component trained by a reinforcement learning operation based on the first compiled object and the feedback signal, a second mapping object; and
outputting the second mapping object for execution by a map engine.

13. The computer-implemented method of claim 12, wherein the at least one compiler error comprises a plurality of compiler errors, and wherein the feedback signal indicates, for each compiler error of the plurality of compiler errors, a corresponding feedback stage and an associated intensity level.

14. The computer-implemented method of claim 12, wherein the at least one compiler error comprises an error code of a set three or more error codes.

15. The computer-implemented method of claim 12, wherein performing the compiling operation comprises:
compiling the first mapping object into the first compiled object;
obtaining a set of input data; and
executing the first compiled object based on the input data, wherein the data error comprises a dynamic data error associated with the executing the first compiled object.

16. The computer-implemented method of claim 12, wherein the at least one compiler error comprises a plurality of compiler errors and wherein, generating the second mapping object comprises:
training the machine learning component to mitigate compiler errors of the plurality of compiler errors according to a priority scheme.

17. A computer program product comprising:
one or more computer-readable storage media; and
program instructions stored on the one or more computer-readable storage media to perform operations comprising:
generating a first mapping object comprising electronic data interchange mapping source code;
performing a compiling operation to compile the first mapping object into a first compiled object;
generating, based on the compiling operation, a feedback signal comprising at least one compiler error or at least one data error;
generating, by a machine learning component trained by a reinforcement learning operation based on the first compiled object and the feedback signal, a second mapping object; and
outputting the second mapping object for execution by a map engine.

18. The computer program product of claim 17, wherein generating the second mapping object comprises:
providing error data, based on the feedback signal, to an error encoder of the machine learning component to generate an error context vector;
providing code data, based on the feedback signal, to a code encoder of the machine learning component to generate a code context vector;
providing sample input data to an input encoder of the machine learning component to generate an input context vector;
providing sample output data to an output encoder of the machine learning component to generate an output context vector;
combining the error context vector, the code context vector, the input context vector, and the output context vector into a combined in-context vector; and
providing the combined in-context vector to a decoder of the machine learning component to generate the second mapping object.

19. The computer program product of claim 17, wherein the machine learning component comprises at least one encoder trained to process a code syntax associated with the first and second mapping objects.

20. The computer program product of claim 19, the operations further comprising generating, based on the at least one encoder, at least one of a code explanation tool or a code search tool.
